(19) United States
(12) Patent Application Publication
(10) Pub. No.: US 2024/0144692 A1
(43) Pub. Date: May 2, 2024

(54) PEOPLE DETECTOR

(71) Applicant: ASSA ABLOY AB, Stockholm (SE)

(72) Inventor: Tomas Jonsson, Rönninge (SE)

(21) Appl. No.: 18/546,824

(22) PCT Filed: Feb. 17, 2022
(86) PCT No.: PCT/EP2022/053977

§ 371 Date: Aug. 17, 2023

(30) Foreign Application Priority Data
Feb. 18, 2021 (SE) 2150173-9

(51) Int. Cl. G06V 20/52; E05F 15/73; G06V 10/25

(52) U.S. Cl. CPC G06V 20/52; E05F 15/73; G06V 10/25; E05F 2015/767; E05Y 2900/132

(57) ABSTRACT

It is provided a people detector for detecting when people pass through a doorway of a door by which the people detector is installed. The people detector comprises: a people sensor; a processor; and a memory storing instructions that, when executed by the processor, cause the people detector to: receive a door status signal indicating opening status of the door; determine when a person passes through the doorway based on the people sensor and the door status signal.

### TECHNICAL FIELD

The present disclosure relates to the field of people detectors and in particular to people detectors for detecting when people pass through a doorway of a door by which the people detector is installed

### BACKGROUND

People detectors can be used in many different environments. For instance, people detectors can be used to detect flows of people e.g. in a theme park or a shopping centre. People detectors can also be used to count people in a certain space, such as commercial or residential properties, to thereby control Heat, Ventilation and Air Conditioning (HVAC) or for keeping track of the number of people in a certain space, e.g. for fire protection purposes or office utilisation metrics.

There are people detectors that provide good accuracy, e.g. based on conventional digital cameras, but these are quite costly and require significant amount of power.

Power use is of great importance. If a people detector can be provided that is both power efficient and accurate, this makes the installation easier and cheaper. Power use is of great importance. If a people detector can be provided that is both power efficient and accurate, this makes the installation easier since such a people detector can be battery powered, reducing or eliminating the need for cumbersome and expensive wiring.

### SUMMARY

One object is to provide a people counter that is inexpensive and power efficient.

According to a first aspect, it is provided a people detector for detecting when people pass through a doorway of a door by which the people detector is installed. The people detector comprises: a people sensor being configured to provide an image; a processor; and a memory storing instructions that, when executed by the processor, cause the people detector to: receive a door status signal indicating opening status of the door, wherein the door status signal is a signal capable of indicating fully open, closed and a plurality of different extents of opening between fully open and closed; and determine when a person passes through the doorway based on the people sensor and the door status signal; wherein the instructions to determine comprise instructions that, when executed by the processor, cause the people detector to: estimate where, in the image, the door will be represented based on the door status signal; and exclude a region in the image where the door is estimated to be.

The people detector may be configured to transition from a low-power state to an active state when the door status signal indicates that the door is open more than a threshold amount.

The people detector may be configured to transition from the active state to the low-power state when the door status signal indicates that the door is open less than the threshold amount.

The instructions to determine may comprise instructions that, when executed by the processor, cause the people detector to: determine how many people pass through the doorway based on the timing of the door status signal.

The instructions to determine may comprise instructions that, when executed by the processor, cause the people detector to: determine how many people pass through the doorway based on how the door status signal varies over time.

The instructions to estimate may comprise instructions that, when executed by the processor, cause the people detector to: estimate where, in the image, the door will be represented based on the door status signal and depth data of the image.

The instructions to determine may comprise instructions that, when executed by the processor, cause the people detector to: exclude a region in the image on a distal side of the estimated position of the door, the distal side being distal from a doorway.

The instructions to determine may comprise instructions that, when executed by the processor, cause the people detector to: exclude a central region in the image.

The instructions to exclude may comprise instructions that, when executed by the processor, cause the people detector to ignore the excluded regions in subsequent processing to determine when a person passes through the doorway.

The instructions to exclude may comprise instructions that, when executed by the processor, cause the people detector to prevent the excluded regions from being received from the people sensor.

According to a second aspect, it is provided a method for detecting when people pass through a doorway of a door by which a people detector is installed. The method is performed in the people detector. The method comprises: receiving a door status signal indicating opening status of the door, wherein the door status signal is a signal capable of indicating fully open, closed and a plurality of different extents of opening between fully open and closed; obtaining a sensor signal from a people sensor of the people detector, wherein the people sensor provides an image; and determining when a person passes through the doorway based on the door status signal and the sensor signal; wherein the determining comprises: estimating where, in an image from the people sensor, the door will be represented based on the door status signal; and excluding a region in the image where the door is estimated to be.

The method may further comprise: transitioning from a low-power state to an active state when the door status signal indicates that the door is open more than a threshold amount.

The method may further comprise: transitioning from the active state to the low-power state when the door status signal indicates that the door is open less than the threshold amount.

The determining may comprise determining how many people pass through the doorway based on the timing of the door status signal.

The determining may comprise determining how many people pass through the doorway based on how the door status signal varies over time.

The estimating may comprise estimating where, in the image, the door will be represented based on the door status signal and depth data of the image.

The determining may comprise: excluding a region in the image on a distal side of the estimated position of the door, the distal side being distal from a doorway.

The determining may comprise: excluding a central region in the image.

The excluding may comprise ignoring the excluded regions in subsequent processing to determine when a person passes through the doorway.

The excluding may comprise preventing the excluded regions from being received from the people sensor.

According to a third aspect, it is provided a computer program for detecting when people pass through a doorway of a door by which a people detector is installed. The computer program comprises computer program code which, when executed on a people detector causes the people detector to: receive a door status signal indicating opening status of the door, wherein the door status signal is a signal capable of indicating fully open, closed and a plurality of different extents of opening between fully open and closed; and determine when a person passes through the doorway based on the door status signal and a people sensor of the people detector, wherein the people sensor provides an image; wherein the computer program code to determine comprises computer program code which, when executed on a people detector causes the people detector to: estimate where, in an image from the people sensor, the door will be represented based on the door status signal; and exclude a region in the image where the door is estimated to be.

According to a fourth aspect, it is provided computer program product comprising a computer program according to the third aspect and a computer readable means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating an environment in which embodiments presented herein can be applied;

FIGS. 2A-C are schematic diagrams of areas of images of sensor signals that can be excluded to improve performance;

FIGS. 3A-B are flow charts illustrating embodiments of methods for detecting when people pass through a doorway by a door by which a people detector is installed;

FIG. 4 is a state diagram illustrating power states and transitions therebetween of the people detector;

FIG. 5 is a schematic diagram illustrating components of the people detector of FIG. 1; and

FIG. 6 shows one example of a computer program product 90 comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

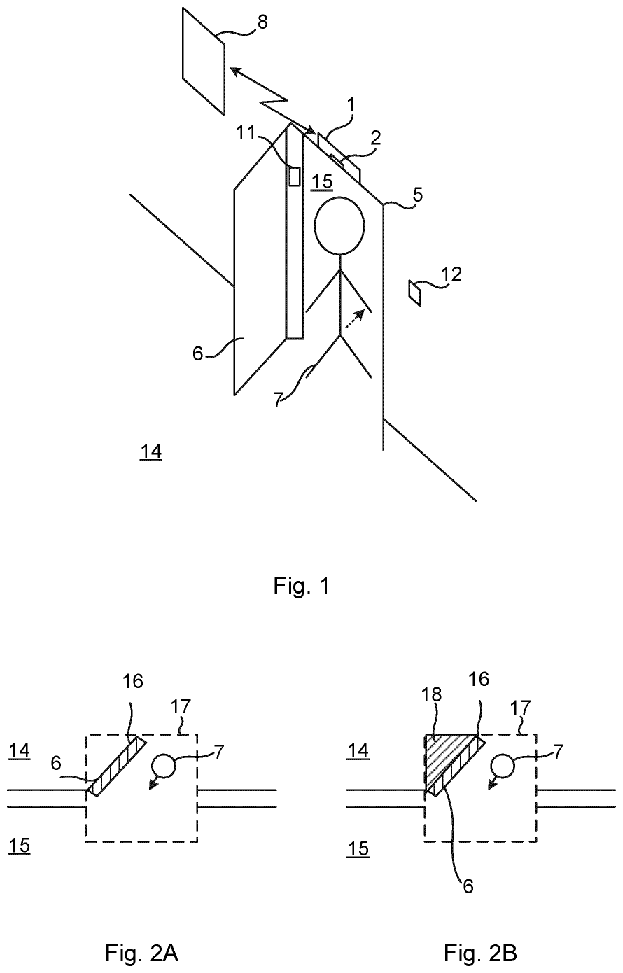

FIG. 1 is a schematic diagram illustrating an environment in which embodiments presented herein can be applied. Access between a first physical space 14 and a second physical space 15 is restricted by a door 6 which can be closed or open. The door 6 can be any type of door (e.g. hinged, sliding, roller) and is provided in a doorway 5 between the first physical space 14 and a second physical space 15. In order to control access in either or both direction between the physical spaces 14, 15 a lock device 12 can be provided to selectively unlock and lock the door 6. The opening status of the door 6, e.g. open or closed, can be detected by a door sensor 11. The door sensor 11 can be provided in the door frame (as shown), in the door 6, using sections in both the door frame and the door, in hinges, in a door closer (not shown) or in a door opener. The door sensor 11 can detect the opening status of the door 6 in any suitable manner e.g. using a magnetometer and magnet, using electrical resistance, using impedance, using visual sensing or using an accelerometer and/or gyro.

A people detector 1 is installed by the door 6, in this case in the doorway 5. The people detector can be a separate device, or it can be installed in a door closer, door opener, in an electronic lock, in a credential reader or an EAC (Electronic Access Control) button for unlocking or opening the door. The people detector 1 comprises a people sensor 2 which is directed to detect any people passing through the doorway 5. In this way, the people detector can detect when someone enters the first physical space 14 from the second physical space 15 and vice versa. The people sensor 2 can be mounted on the doorframe (e.g. on the horizontal upper part of the doorframe pointing downwards), on a door closer (either on the doorframe part or the door part) or on the door itself. When the people sensor 2 is mounted on the doorframe, the people sensor 2 can be installed sufficiently low to capture an image covering part of both the first physical space 14 and the second physical space 15. The people sensor 2 can be used as part of a safety device that, when the presence of a person (or object) is detected, prevents that the door crashes with a person (or object) during closing or opening.

The people sensor 2 can e.g. be based on capturing an image of the space by the doorway in two dimensions (2D) or three dimensions (3D), e.g. based on Time-of-Flight (ToF) detection, visual imaging (i.e. a camera), infrared detection, thermal detection, lidar, radar, etc. It is to be noted that the term ‘image’ is to be interpreted broadly as any captured representation of the local physical environment. Hence, the image can be represented as a 2D array of pixels, a 2D array of pixels with depth data added for each pixel, a point cloud (in 3D space), a set of polygons in 3D space, etc.

It is to be noted that the resolution of the people sensor 2 can be very low, e.g. 8×8 or 4×4 pixels, since the main purpose is to detect presence of people, for which such low resolution is sufficient. Moreover, the fewer pixels to process, the less power is needed for the processing to detect people. Nevertheless, the embodiments presented herein can equally well be applied with a people sensor that has a much higher resolution. When the people sensor is based on a ToF sensor or other 3D sensor, each pixel can have a depth value, indicating (average or minimum) distance to an object within the angular space covered by the people sensor. Optionally, each pixel contains a set of measurements indicating respective distances to objects at different positions within the pixel.

The people sensor 2 of the people detector 1 is thus capable of detecting when a person 7 moves to the first physical space 14 from the second physical space 15 (and vice versa). The number of people passing through can also be detected. This can be utilised when an intruder attempts to enter a restricted physical space by passing right after a person with legitimate access, a procedure which is also known as piggybacking.

The detection of a person 7, and optionally a direction of movement, by the people sensor 2 is recorded by the people detector 1 and the people detector 1 can communicate this information to an external device 8. The external device 8 can be an alarm system, a building automation system or any other suitable device. The external device 8 can be at the same site as the people detector 1 or it can be remotely located.

The external device 8 can use the people detection information to determine e.g. how many people are in the first physical space 14 and/or the second physical space 15. This information can be used by the external device 8 e.g. to control ventilation, heating, cooling and/or lighting. Moreover, this information can be used for office utilisation metrics, e.g. enabling personnel to plan when to go to the office (rather than working from home) when utilisation is low. Alternatively or additionally, the people detection information can be used if an emergency occurs, to know where people are located and how many people there are to evacuate. Alternatively or additionally, this information can be used for people flow statistics, e.g. for theme parks, public transport stations, and shops.

When there is only one doorway to a physical space (e.g. a room, office or home), the people detector 1 can thus be used count how many people are in the physical space at any point in time. When there are multiple doorways to a physical space, each doorway can be provided with a people detector. This enables the external device to keep track of the number of people in the physical space by detecting each time someone enters or exits through any of the doorways.

A physical space (for which the number of people is kept track of) can be any type of space where people can be present. Hence, the physical space can be any one or more of a room, a set of rooms (e.g. an office), a home, a shop, an arena, a theme park or any other commercial or residential space.

Optionally, physical spaces are arranged in a hierarchy, such that several physical spaces are represented collectively by an access zone, e.g. in an office environment. In this way, the external device 8 can keep track of the number of people in each physical space (e.g. room) and also in the combined access zone (e.g. an office building). The number of people in each access zone (based on the people counting) can be compared with the number of persons having entered using the access control system, which can thereby be used to detect the occurrence of piggybacking.

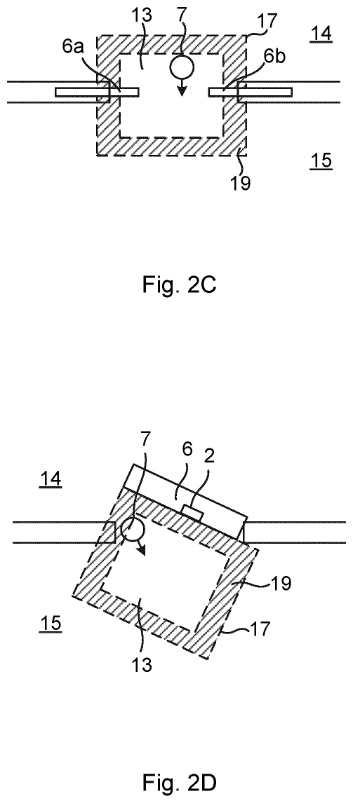

FIGS. 2A-C are schematic diagrams of areas of images of sensor signals that can be excluded to improve performance. The diagrams are top views of the environment of FIG. 1, showing relevant details. The user 7 has opened the door 6 and is in process of entering the second physical space 15 from the first physical space 14, i.e. in the direction shown by the arrow. The people sensor is capable of capturing an image corresponding to the indicated field of view 17. The field of view 17 can be configured to capture an image covering both the first physical space 14 and the second physical space 15 or only the first physical space 14. It is to be noted that the field of view 17 illustrated here is the field of view at a height plane, at a specific height over the floor. This height can e.g. be 0, 1.2 m or 1.8 m, or any other height, above the floor. Depending on how tall the user 7 is and the height of the field of view, the position of the user 7 in the field of view 17 can vary, which may be considered in the processing. However, regardless of how tall the user 7 is, the user 7 will pass through the doorway and will be detectable by the people sensor.

In FIG. 2A, a region 16 in the image corresponding to the door 6 is shown. In this scenario, the door 6 is a side-hinged door. Since a person cannot be located there, this region 16 can safely be excluded when determining the presence or absence of a person.

In FIG. 2B, in addition to the region 16 corresponding to the door of FIG. 2A, a distal region 18 is shown which is on a distal side of the position of the door, wherein the distal side is distal from the doorway 5. This distal region 18 can also be excluded when determining the presence of absence of a person passing through the doorway, since if the person were to be in the distal region 18, she needs to come around the door to pass through the doorway, in which case the person 7 will be detected, since at most, the door region 16 and the distal region 18 are excluded.

In FIG. 2C, a scenario is shown where the door 6 is implemented using a pair of sliding doors 6a-6b. In this example, the field of view 17 is sectioned into a peripheral region 19 and a central region 13. As long as the people sensor can detect people passing through the peripheral region 19, the people sensor can function as desired. Hence, pixels in the central region 13 can be excluded when determining the presence or absence of a person passing through the doorway, since that person can be detected on either side of the peripheral region 19 when passing through, or twice in the peripheral region 19 if the person turns around. It is to be noted that the exclusion of a central region can also be applied in combination with the scenarios illustrated in FIG. 2A and FIG. 2B, i.e. also with a hinged door.

In FIG. 2D, a scenario is shown where the people sensor 2 is mounted to move along with movement of the door 6. For instance, the people sensor 2 can be mounted on the door itself or on a door part of a door closer or door opener.

In this scenario, pixels of the peripheral region 19 of the field of view can be excluded, since a person needs to pass through the central region 13 to pass through the door.

By excluding certain regions for determining presence or absence of people, less space of the image needs to be processed to determine when a person passes through the doorway. By processing less of the image, especially when processing many images over time, the processing consumes much less energy, making it more feasible to implement the people detector using battery power. For instance, there are cameras with a 128×128 pixel resolution that consume very small amounts of power, whereby most power consumption comes from the data processing. Hence, the reduction in processing of data can result in significant reductions of power consumption.

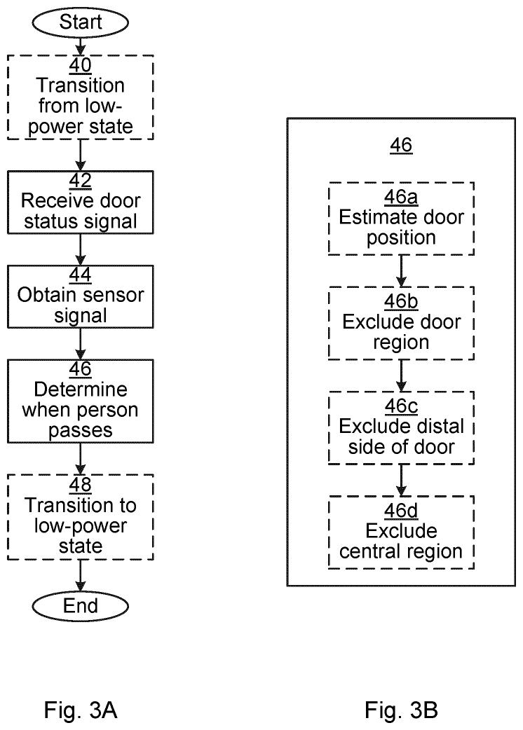

FIGS. 3A-B are flow charts illustrating embodiments of methods for detecting when people pass through a doorway 5 by a door by which a people detector 1 is installed. The method is performed in the people detector 1.

In an optional transition from low-power state step 40, the people detector 1 transitions from a low-power state to an active state when the door status signal indicates that the door is open more than a threshold amount. The threshold amount is defined such that a person cannot pass through the door (or more correctly the doorway) when the door is open less than the threshold amount. One special case is that the threshold amount is zero extent of opening, corresponding to the door being fully closed. However, the amount of time in the active state is reduced if the threshold amount is greater than zero, leading to greater reduction in power consumption.

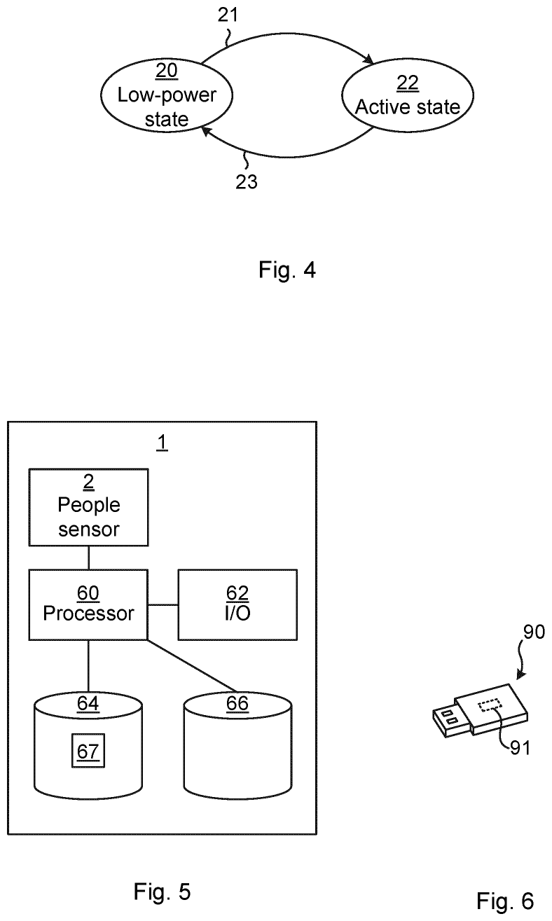

In this way, the people detector is in the low-power state until the door is open sufficiently to allow a person through, saving power. Any reduction in time that the people detector 1 is in the active state results in improved power efficiency. This step corresponds to the transition 21 from a low-power state 20 to an active state 22 shown in FIG. 4 and described below. In a receive door status signal step 42, the people detector 1 receives a door status signal indicating opening status of the door. The door status signal is a signal capable of indicating fully open, closed and a plurality of different extents of opening between fully open and closed. For instance, the door status signal can be a state in an enumeration of potential states, e.g. an enumeration of degrees of opening such as {0, 15, 30, 45, 60, 75, 90}, where the closest match is selected. Alternative, the door status signal can be a numerical (integer or floating point) value indicating the degree of opening e.g. in the range of [0, 1], where 0 indicates closed and 1 indicates fully open, or [0, 180], where 0 indicates closed and 180 indicates 180 degrees of opening. It is to be noted that the examples of 90 degrees and 180 degrees of fully open door are only two examples and the embodiments presented herein can be applied for any value of degree for fully open. Alternatively, the door status signal is an analogue electrical signal. The degree metric is mainly applicable when the door is a hinged door. For sliding doors or roller doors, the other types of metrics are more applicable.

In an obtain sensor signal step 44, the people detector 1 obtains a sensor signal from a people sensor 2 of the people detector 1. The sensor signal can contain an image an image captured, e.g. using an IR camera or a digital camera. The image covers a field of view 17 by the doorway. As explained above, the resolution of the people sensor 2 can be very low to reduce processing power need. The number of pixels in the image can be less than 100, e.g. 8×8 pixels or even less, such as 4×4 pixels, especially when ToF sensors are used that also contain depth data. For a camera, 128×128 pixels can be used. It has been found that processing of many pixels consumes significantly more power, which is desired to be avoided.

In a determine when person passes step 46, the people detector 1 determines when a person passes through the doorway based on the door status signal and the sensor signal. Optionally, this step also comprises determining a direction of movement of the person through the doorway, e.g. by examining the position of the person in the image in several successive images of the sensor signal.

The determination in this signal can be rule-based or based on a machine-learning model where the inputs are the door status signal and the sensor signal (e.g. the pixel values of the image in the sensor signal), and where the output is an indication of a person. When the people sensor 2 is fixed on the door, the reference for the sensor signal is the door, which makes rule-based determination of a person slightly more complicated. However, the machine-learning model can then be used to interpret the sensor signal based on the door status signal (e.g. indicating an extent of opening of the door), since the model will have been trained based on the people sensor being located on the door, whereby the training removes this complexity in an elegant way.

This step can comprise determining how many people pass through the doorway based on the timing of the door status signal. For instance, if the door closes again in a time period less than a threshold time, it can be determined that only a single person passed through the doorway, i.e. no piggybacking occurred. If it takes longer than the threshold time for the door to close again, this can indicate that piggybacking is suspected. Optionally, the timing can be combined with the door status signal, e.g. in a rule where if the door is closing after a person walks through and the door status signal indicates a new opening, this indicates piggybacking. This can also be determined using the machine-learning model mentioned above, where also the timing of signals is used in the machine learning model and optionally with an additional piggyback indicator as an output signal

Alternatively or additionally, this step comprises determining how many people pass through the doorway based on how the door status signal varies over time. For instance, if the door status signal first indicates gradual opening, followed by gradual closing until the door is closed, this can indicate a single person passing through the doorway. On the other hand, if the door status signal first indicates gradual opening, followed by partial gradual closing, gradual opening again and finally a gradual closing until the door is closed, this can indicate that a person is piggybacking. A door closer has a normal closing speed. Hence, when the closing of the door, as indicated by the door status signal, does not follow the normal closing speed, this is determined to be a piggybacking indicator. In other words, the door status signal improves the ability to detect piggybacking.

When piggybacking is determined or suspected, this can be reported to the external device.

The method can return to the receive door status signal step 42, to process a new image and a new door status, optionally after a wait (not shown). This can proceed until the door status signal indicates that the door is closed more than the threshold amount again, at which point the people detector can assume the low-power state to save power.

In an optional transition to low-power state step 48, the people detector transitioning from the active state to the low-power state when the door status signal indicates that the door is open less than the threshold amount.

Looking now to FIG. 3B, this discloses sub-steps of the determine when person passes step 46.

In an estimate door position sub-step 46a, the people detector 1 estimates where, in the image from the people sensor 2, the door will be represented. This estimation is based on the door status signal, i.e. how open the door is, e.g. indicating an approximate angle of opening of the door. Optionally, the size of the door in the image is also known, e.g. by configuration at installation, to allow a more accurate determination of the door position. Optionally, the door position is estimates where, in the image, the door is depicted based on the door status signal and depth data of the image. For instance, an expected depth value of each pixel can be determined based on the door status signal and known geometry of the door. If a body part of a person is present in a pixel in front of the door, this is reflected in a depth value indicating the intermediate body part.

In an exclude door region sub-step 46b, the people detector 1 excludes a region in the image where the door is estimated to be, based on the estimation in sub-step 46a and optionally a width of the door. This door region is illustrated in FIG. 2A and is explained above. The door region can be defined as a set of pixels in the image.

In an optional exclude distal side of door sub-step 46c, the people detector 1 excluding 46c a region in the image on a distal side of the estimated position of the door, the distal side being distal from a door opening. This distal region is illustrated in FIG. 2B and is explained above. The distal region can be defined as a set of pixels in the image.

In an optional exclude central region step 46d, the people detector 1 excludes a central region 13 in the image, as illustrated in FIG. 2C and explained above.

The excluding in the exclude door region sub-step 46b and/or the exclude distal side of door sub-step 46c can comprises ignoring the excluded regions in subsequent processing to determine when a person passes through the doorway.

Alternatively, the excluding in the exclude door region sub-step 46b and/or the exclude distal side of door sub-step 46c comprises preventing the excluded regions from being received from or by the people sensor 2, e.g. by refraining from reading pixels of the excluded region(s) from the people sensor or by refraining from obtaining lidar or radar (beam) data for the excluded region.

Using embodiments presented herein, a people detector is provided that is very power efficient. This allows the people detector to be battery powered, which significantly simplifies installation. Moreover, the embodiments presented herein can be implemented using a very simple, low-resolution people sensor, saving cost and processing power. The people detecting can be used to trigger a door closer to close quicker when the person has passed through the doorway.

FIG. 4 is a state diagram illustrating power states and transitions therebetween of the people detector 1.

In a low-power state 20, the people detector 1 is inactive and may be configured to only respond to signals which can cause the people detector 1 to transition to an active state 22. In this state, power use is extremely low to save e.g. battery power.

In the active state 22, the people detector 1 is fully active and can use all sensors, processing and communication capabilities.

The people detector 1 can transition 21 from the low-power state 20 to the active state 22, e.g. when the door status signal indicates that the door changes from being open less than a threshold amount to being open more than a threshold amount. or when a lock of the door is unlocked. For the reverse direction, the people detector 1 can transition 23 from the active state 22 to the low-power state 20 e.g. when the door status signal indicates that the door changes from being open more than a threshold amount to being open less than a threshold amount or when a lock of the door is locked.

FIG. 5 is a schematic diagram illustrating components of the people detector 1 of FIG. 1. A processor 60 is provided using any combination of one or more of a suitable central processing unit (CPU), graphics processing unit (GPU), multiprocessor, microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the method described with reference to FIGS. 3A-B above.

The memory 64 can be any combination of random-access memory (RAM) and/or read-only memory (ROM). The memory 64 also comprises persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM.

The people detector 1 further comprises an I/O interface 62 for communicating with external and/or internal entities. Optionally, the I/O interface 62 also includes a user interface.

A people sensor 2 is configured to detect when one or more people are present within a field of view. As described above, the people sensor 2 can capture an image to thereby allow the detection of people, e.g. using an IR camera or a camera for visual light.

Other components of the people detector 1 are omitted in order not to obscure the concepts presented herein.

FIG. 6 shows one example of a computer program product 90 comprising computer readable means. On this computer readable means, a computer program 91 can be stored, which computer program can cause a processor to execute a method according to embodiments described herein. In this example, the computer program product is in the form of a removable solid-state memory, e.g. a Universal Serial Bus (USB) drive. As explained above, the computer program product could also be embodied in a memory of a device, such as the computer program product 64 of FIG. 5. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

Here now follows a list of embodiments enumerated with roman numerals.

i. A people detector for detecting when people pass through a doorway of a door by which the people detector is installed, the people detector comprising:
a people sensor;
a processor; and
a memory storing instructions that, when executed by the processor, cause the people detector to:
receive a door status signal indicating opening status of the door;
determine when a person passes through the doorway based on the people sensor and the door status signal.

ii. The people detector according to embodiment i, wherein the people detector is configured to transition from a low-power state to an active state when the door status signal indicates that the door is open more than a threshold amount.

iii. The people detector according to embodiment i or ii, wherein the people detector is configured to transition from the active state to the low-power state when the door status signal indicates that the door is open less than the threshold amount.

iv. The people detector according to any one of the preceding embodiments, wherein the door status signal is a signal capable of indicating fully open, closed and a plurality of different extents of opening between fully open and closed.

v. The people detector according to embodiment iv, wherein the instructions to determine comprise instructions that, when executed by the processor, cause the people detector to:
determine how many people pass through the doorway based on the timing of the door status signal.

vi. The people detector according to embodiment iv or v, wherein the instructions to determine comprise instructions that, when executed by the processor, cause the people detector to:
determine how many people pass through the doorway based on how the door status signal varies over time.

vii. The people detector according to any one of embodiments iv to vi, wherein the people sensor is configured to provide an image, and wherein the instructions to determine comprise instructions that, when executed by the processor, cause the people detector to:
estimate where, in the image, the door will be represented based on the door status signal; and
exclude a region in the image where the door is estimated to be.

viii. The people detector according to embodiment vii, wherein the instructions to estimate comprise instructions that, when executed by the processor, cause the people detector to:
estimate where, in the image, the door will be represented based on the door status signal and depth data of the image.

ix. The people detector according to embodiment vii to viii, wherein the instructions to determine comprise instructions that, when executed by the processor, cause the people detector to:
exclude a region in the image on a distal side of the estimated position of the door, the distal side being distal from a doorway.

x. The people detector according to embodiment vii to ix, wherein the instructions to determine comprise instructions that, when executed by the processor, cause the people detector to:
exclude a central region in the image.

xi. The people detector according to any one of embodiments vii to x, wherein the instructions to exclude comprise instructions that, when executed by the processor, cause the people detector to ignore the excluded regions in subsequent processing to determine when a person passes through the doorway.

xii. The people detector according to any one of embodiments vii to x, wherein the instructions to exclude comprise instructions that, when executed by the processor, cause the people detector to prevent the excluded regions from being received from the people sensor.

xiii. A method for detecting when people pass through a doorway of a door by which a people detector is installed, the method being performed in the people detector, the method comprising:
receiving a door status signal indicating opening status of the door;
obtaining a sensor signal from a people sensor of the people detector; and
determining when a person passes through the doorway based on the door status signal and the sensor signal.

xiv. The method according to embodiment xiii, further comprising:
transitioning from a low-power state to an active state when the door status signal indicates that the door is open more than a threshold amount.

xv. The method according to embodiment xiii or xiv, further comprising:
transitioning from the active state to the low-power state when the door status signal indicates that the door is open less than the threshold amount.

xvi. The method according to any one of embodiments xiii to xv, wherein the door status signal is a signal capable of indicating fully open, closed and a plurality of different extents of opening between fully open and closed.

xvii. The method according to embodiment xvi, wherein the determining comprises determining how many people pass through the doorway based on the timing of the door status signal.

xviii. The method according to embodiment xvi or xvii, wherein the determining comprises determining how many people pass through the doorway based on how the door status signal varies over time.

xix. The method according to any one of embodiments xvi to xviii, wherein the determining comprises:
estimating where, in an image from the people sensor, the door will be represented based on the door status signal; and
excluding a region in the image where the door is estimated to be.

xx. The method according to embodiment xix, wherein estimating comprises estimating where, in the image, the door will be represented based on the door status signal and depth data of the image.

xxi. The method according to embodiment xix or xx, wherein the determining comprises:
excluding a region in the image on a distal side of the estimated position of the door, the distal side being distal from a doorway.

xxii. The method according to any one of embodiments xix to xxi, wherein the determining comprises:
excluding a central region in the image.

xxiii. The method according to any one of embodiments xix to xxii, wherein the excluding comprises ignoring the excluded regions in subsequent processing to determine when a person passes through the doorway.

xxiv. The method according to any one of embodiments xix to xxii, wherein the excluding comprises preventing the excluded regions from being received from the people sensor.

xxv. A computer program for detecting when people pass through a doorway of a door by which a people detector is installed, the computer program comprising computer program code which, when executed on a people detector causes the people detector to:
receive a door status signal indicating opening status of the door;
determine when a person passes through the doorway based on the door status signal and a people sensor of the people detector.

xxvi. A computer program product comprising a computer program according to embodiment xxv and a computer readable means on which the computer program is stored.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A people detector for detecting when people pass through a doorway of a door by which the people detector is installed, the people detector comprising:
a people sensor being configured to provide an image;
a processor; and
a memory storing instructions that, when executed by the processor, cause the people detector to:
receive a door status signal indicating opening status of the door, wherein the door status signal is a signal capable of indicating fully open, closed, and a plurality of different extents of opening between fully open and closed; and
determine when a person passes through the doorway based on the people sensor and the door status signal;
wherein the instructions to determine comprise instructions that, when executed by the processor, cause the people detector to:
estimate where, in the image, the door is represented based on the door status signal;
exclude a region in the image where the door is estimated to be represented; and
exclude a region in the image on a distal side of where the door is estimated to be represented, the distal side being distal from the doorway.

2. The people detector according to claim 1, configured to configure the people detector to be in an active state when the door status signal indicates that the door is open more than a threshold amount.

3. The people detector according to claim 1, configured to configure the people detector to be in a low-power state when the door status signal indicates that the door is open less than the threshold amount.

4. The people detector according to claim 1, wherein the instructions to determine comprise instructions that, when executed by the processor, cause the people detector to:
determine how many people pass through the doorway based on how long the door stays open.

5. The people detector according to claim 1, wherein the instructions to determine comprise instructions that, when executed by the processor, cause the people detector to:
determine how many people pass through the doorway based on how the door status signal varies over time.

6. The people detector according to claim 1, wherein the instructions to estimate comprise instructions that, when executed by the processor, cause the people detector to:
estimate where, in the image, the door is represented based on the door status signal and depth data of the image.

7. The people detector according to claim 1, wherein the instructions to determine comprise instructions that, when executed by the processor, cause the people detector to:
exclude a central region in the image.

8. The people detector according to claim 1, wherein the instructions to exclude comprise instructions that, when executed by the processor, cause the people detector to ignore the excluded regions in subsequent processing to determine when a person passes through the doorway.

9. The people detector according to claim 1, wherein the instructions to exclude comprise instructions that, when executed by the processor, cause the people detector to prevent the excluded regions from being received from the people sensor.

10. A method for detecting when people pass through a doorway of a door by which a people detector is installed, the method being performed in the people detector, the method comprising:
receiving a door status signal indicating opening status of the door, wherein the door status signal is a signal capable of indicating fully open, closed, and a plurality of different extents of opening between fully open and closed;
obtaining a sensor signal from a people sensor of the people detector, wherein the people sensor provides an image; and
determining when a person passes through the doorway based on the door status signal and the sensor signal;
wherein the determining comprises:
estimating where, in an image from the people sensor, the door is represented based on the door status signal;
excluding a region in the image where the door is estimated to be represented; and
excluding a region in the image on a distal side of where the door is estimated to be represented, the distal side being distal from the doorway.

11. The method according to claim 10, further comprising:
configuring the people detector to be in an active state when the door status signal indicates that the door is open more than a threshold amount.

12. The method according to claim 10, further comprising:
configuring the people detector to be in a low-power state when the door status signal indicates that the door is open less than the threshold amount.

13. The method according to claim 10, wherein the determining comprises determining how many people pass through the doorway based on how long the door stays open.

14. The method according to claim 10, wherein the determining comprises determining how many people pass through the doorway based on how the door status signal varies over time.

15. The method according to claim 10, wherein estimating comprises estimating where, in the image, the door is represented based on the door status signal and depth data of the image.

16. The method according to claim 10, wherein the determining comprises:
excluding a central region in the image.

17. The method according to claim 10, wherein the excluding comprises ignoring the excluded regions in subsequent processing to determine when a person passes through the doorway.

18. The method according to claim 10, wherein the excluding comprises preventing the excluded regions from being received from the people sensor.

19. A non-transitory computer readable medium storing a computer program for detecting when people pass through a doorway of a door by which a people detector is installed, the computer program comprising computer program code which, when executed on the people detector causes the people detector to:
receive a door status signal indicating opening status of the door, wherein the door status signal is a signal capable of indicating fully open, closed and a plurality of different extents of opening between fully open and closed; and
determine when a person passes through the doorway based on the door status signal and a people sensor of the people detector, wherein the people sensor provides an image;
wherein the computer program code to determine comprises computer program code which, when executed on the people detector causes the people detector to:
estimate where, in an image from the people sensor, the door is represented based on the door status signal;
exclude a region in the image where the door is estimated to be represented; and
exclude a region in the image on a distal side of the door, the distal side being distal from the doorway.

20. (canceled)
